(19) United States
(12) Patent Application Publication
(10) Pub. No.: US 2009/0113325 A1
(43) Pub. Date: Apr. 30, 2009

(54) METHODS AND SYSTEMS FOR MANUFACTURING TRACKING

(76) Inventor: Jim Phillips, Loganville, GA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/062,799

(22) Filed: Apr. 4, 2008

Related U.S. Application Data
(60) Provisional application No. 60/910,046, filed on Apr. 4, 2007.

(51) Int. Cl. G06F 3/048

(52) U.S. Cl. 715/764

(57) ABSTRACT

Provided are methods and systems for creating a custom object comprising selecting an item of manufacture, determining a plurality of fields to describe the item of manufacture, defining at least one of the plurality of fields, generating an associated visual representation of the at least one of the plurality of fields in a view frame, moving the associated visual representation of the at least one of the plurality of fields to a layout frame in response to a design user input, repeating the defining, generating, and moving steps for the plurality of fields that are undefined, resulting in each of the plurality of fields having an associated visual representation in the layout frame, and displaying the layout frame as the custom object.

### CROSS REFERENCE TO RELATED APPLICATION

This application claims priority to U.S. Provisional Application No. 60/910,046 filed Apr. 4, 2007, herein incorporated by reference in its entirety.

### BACKGROUND

For most manufacturing companies, it is difficult to maintain control of the items being manufactured. This is especially true for custom manufacturing facilities due to the levels of details required by each client for each item. Generally, available manufacturing process applications are static.

The data used is set in the application and cannot be changed by the manufacturer user. Additionally, the user interface, also referred to as a GUI (Graphical User Interface), is inflexible and cannot be changed by the manufacturer user. This forces manufacturers, large and small, to conform much of their business to the processes of the application or learn a “work around” in order to make the manufacturing methods and the purchased application work together.

### SUMMARY

Provided are methods and systems for creating a custom traveler comprising selecting an item of manufacture, determining a plurality of fields to describe the item of manufacture, defining at least one of the plurality of fields, generating an associated visual representation of the at least one of the plurality of fields in a view frame, moving the associated visual representation of the at least one of the plurality of fields to a layout frame in response to a design user input, repeating the defining, generating, and moving steps for the plurality of fields that are undefined, resulting in each of the plurality of fields having an associated visual representation in the layout frame, and displaying the layout frame as the custom traveler.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 is a flowchart illustrating an exemplary method;

FIG. 2 is an exemplary Interface Layout Design Console;

FIG. 3 is an exemplary layout frame;

FIG. 4 is an exemplary traveler report;

FIG. 5 is an exemplary “try-out” interface; and

FIG. 6 is an exemplary operating environment.

### DETAILED DESCRIPTION

Before the present methods and systems are disclosed and described, it is to be understood that the methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment.

“Optional” or “optionally” means that the subsequently described event or circumstance may or may not occur, and that the description includes instances where said event or circumstance occurs and instances where it does not. “Design User” refers to a user of the system that creates an interface. “Interface User” refers to a user that uses the interface created. The design user and the interface user can be separate users, or they can be the same user.

The present methods and systems may be understood more readily by reference to the following detailed description of preferred embodiments and the Examples included therein and to the Figures and their previous and following description.

For most manufacturing companies, it can be difficult to maintain individual control of the items being manufactured. This is especially true for custom manufacturing facilities due to the levels of details required by each client for each item. The methods and systems provided allow flexibility with respect to item detail generation so that even customized manufacturing companies can generate “build to specification” orders.

These orders, referred to herein as “travelers,” can be electronically followed through areas that a manufacturer wishes to specify. These areas can include, for example, a customer service department, a computer aided design (CAD) and/or engineering department, quality control department, shipping department, or any range of areas where machine or physical labor are used to manufacture a product. The areas and routing can be specified by a manufacturer. A manufacturer using the methods and systems provided can better manage the manufacturing process.

Many manufacturers schedule work loads with printed or hand written documents that are distributed throughout their facility. These documents become the basis of what each manufacturing area should do and often contain hand written information that is often illegible and dirty as a result of the workplace environment. The provided methods and systems offer a solution for managing when a manufacturing job is due and the flow of manufacturing jobs. Travelers can be scheduled in a way that gives a manufacturer flexibility to modify manufacturing lead times. When a traveler is generated, a customer due date can be provided. Travelers can be assigned a minimum manufacturing start date based on a set of rules from either the traveler's customizable base size or from the traveler's customizable routing hours per manufacturing area.

The methods and systems provided enable a manufacturer to schedule work as it is routed to different manufacturing areas and quickly view not only where a traveler is, but also how much time in machine or man hours has been put in on that item. The methods and systems provided offer a real-time work schedule that can easily show where bottlenecks are in a manufacturing process.

By utilizing employee and machine time logs on travelers, a manufacturer can use the methods and systems provided to track amounts of time spent in order to improve costing capabilities. The methods and systems provided allow a manufacturer to add material usage for each item. Manufacturers can also view historic information for orders and compare labor and materials usage so that a more accurate offer can be made in future orders. The methods and systems provided have a template process whereby an order can be created and then saved. The order can be re-called as a template to generate future orders. This gives the manufacturer the capability to produce orders more efficiently. The methods and systems utilize a manufacturing calendar so that scheduling can be performed more accurately. The manufacturing calendar can be used by marking days as work days, holidays or non-work days. This allows manufacturers to quickly see and print a work calendar for an entire year, for example. This tool can be used when backward scheduling travelers based on due dates and routing information so that the time it takes to make a traveler never calculates using non-work days, holidays or week-ends. Such a tool makes work scheduling more accurate.

The methods and systems can utilize a streamlined user interface that allows information to be found quicker. The methods and systems can utilize a main console that displays current orders and offers for one or more manufacturing customers and orders scheduled to ship. A manufacturer can view an order and view detailed order information, print out travelers, and make and save changes without having to perform excessive searching or having to recall order numbers to locate an order.

The methods and systems can comprise a robust searching tool where manufacturers can easily see a report of orders based on intuitive pieces of information. The report also gives a manufacturer access to make changes to the order or orders that they are attempting to locate. The methods and systems can also utilize a tool for linking historic orders together in a threaded format so that a current order can refer to a previous order which can refer to yet another previous order etc. By “tracing” the orders at any point a manufacturer can view an entire stream of orders as they are linked together. This provides the manufacturer with the ability to compare pieces of information in a way that helps them both build a better product and service their customers.

The methods and systems can utilize time log modules. Through the time log modules manufacturers can track how much time their employees spend in production. The methods and systems can generate a variety of reports that display productivity of employees and/or machines. This enables manufacturers to better manage labor usage and determine a better schedule to avoid problems with costly setup.

The methods and systems can provide a set of communication tools. One such tool can be a messaging system whereby users can send information to other users of the system and know when the recipient has read and even deleted the received message. Messages can be sent to the entire manufacturing organization by use of an alerting console. In one aspect, all current messages can be displayed on a large monitor in a central location so that all personnel have the ability to read the message and be almost instantly informed about new orders, order changes or any other information that the sender wishes to broadcast.

Another communication tool that can be provided by the methods and systems is a task list. The task list allows manufacturers to create and prioritize a to-do list. The tool also allows users to schedule tasks to be completed by other persons and monitor when the task has been or is set to be completed.

With regards to machine and equipment, the methods and systems can provide a maintenance tool that allows users to schedule, view and comment on equipment maintenance to be performed. This is very useful for a manufacturer's upkeep of machines, computers or anything else that manufacturers wish to track.

Most manufacturing process applications available are static. If static, the data used is set in the application and cannot be changed by the manufacturer user. Additionally, the user interface, also referred to as a GUI (Graphical User Interface), is inflexible and cannot be changed by the manufacturer user. This forces manufacturers, large and small, to conform much of their business to the processes of the application or learn a “work around” in order to make the manufacturing methods and the purchased application work together.

Provided is a dynamic manufacturing item customization utility that allows a manufacturer user to change the way a manufacturing item looks in a graphical user interface and also allows a user to add and remove data objects that describe the manufacturing item.

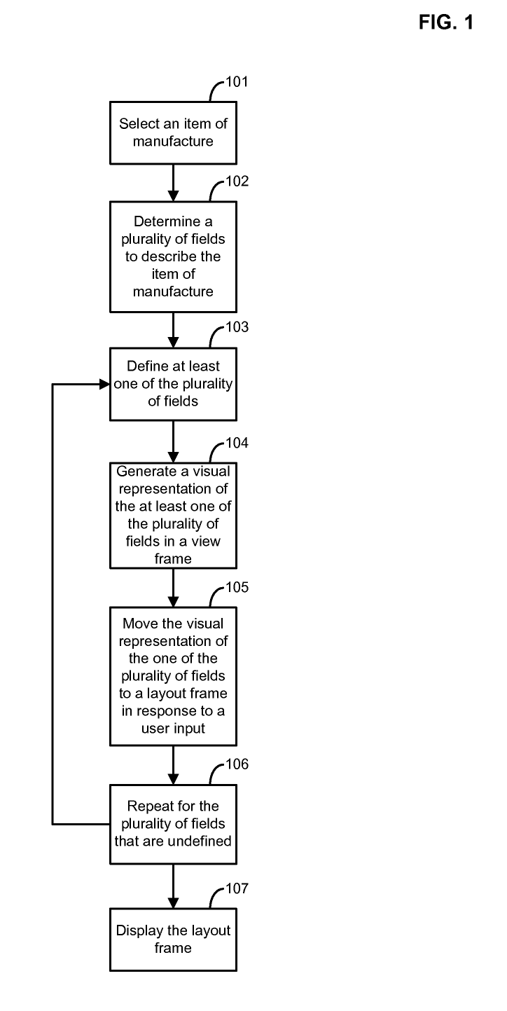

In one aspect, illustrated in FIG. 1, provided are methods for creating a custom object comprising selecting an item of manufacture at block 101, determining a plurality of fields to describe the item of manufacture at block 102, defining at least one of the plurality of fields at block 103, generating an associated visual representation of the at least one of the plurality of fields in a view frame at block 104, moving the associated visual representation of the at least one of the plurality of fields to a layout frame in response to a design user input at block 105, repeating blocks 103-105 for the plurality of fields that are undefined, resulting in each of the plurality of fields having an associated visual representation in the layout frame at block 106, and displaying the layout frame as the custom object at block 107.

In one aspect, the custom object can be a custom traveler. In another aspect, the custom object can be a custom quotation. In an aspect, a field can be a price field. Defining at least one of the plurality of fields can comprise creating one or more pricing formulas. A pricing formula can determine a quote price based on at least one of the plurality of fields.

Determining a plurality of fields to describe the item of manufacture can comprise selecting a previously defined plurality of fields.

Defining at least one of the plurality of fields can comprise creating a name for the at least one of the plurality of fields. Defining at least one of the plurality of fields can comprise selecting a type for the at least one of the plurality of fields. For example, the type can be one of, integer, decimal, text, or yes/no. Defining at least one of the plurality of fields can comprise selecting a value tag for the at least one of the plurality of fields. Defining at least one of the plurality of fields can comprise selecting a field length for the at least one of the plurality of fields. Defining at least one of the plurality of fields can comprise providing a default value for the at least one of the plurality of fields.

In another aspect, moving the associated visual representation of the at least one of the plurality of fields to a layout frame in response to a design user input comprises dragging and dropping the associated visual representation into the layout frame with a computer input device. In an aspect, displaying the layout frame as the custom traveler comprises outputting the custom traveler to a display device.

The methods can comprise an interface or design user logging into a system. For example, the user can be given a user name and password from an administrator. The user can then type in the user name and the password and then either press the Enter key or click on the OK button. The system can then verify the information and either allow or deny access. Once logged in, the user can be directed to a main display.

The main display can comprise menu buttons. One of menu buttons can be labeled “Inventory,” for example. The design user can select the Inventory button to bring up an Inventory Console. Through the Inventory Console, a plurality of items of manufacture can be displayed to the design user and the design user can select an item of manufacture.

After a design user has selected an item of manufacture, the design user can select a button labeled, for example, “Layout Design”. An Item Layout Design Console (ILDC) can be provided to the design user for the selected item of manufacture. If a traveler exists for the selected item of manufacture, the traveler layout is provided. If no traveler exists for the item of manufacture, a blank traveler layout is provided. The design user can either save changes they have made or cancel their changes. Either option can exit the Item Layout Design and return to the Inventory Console.

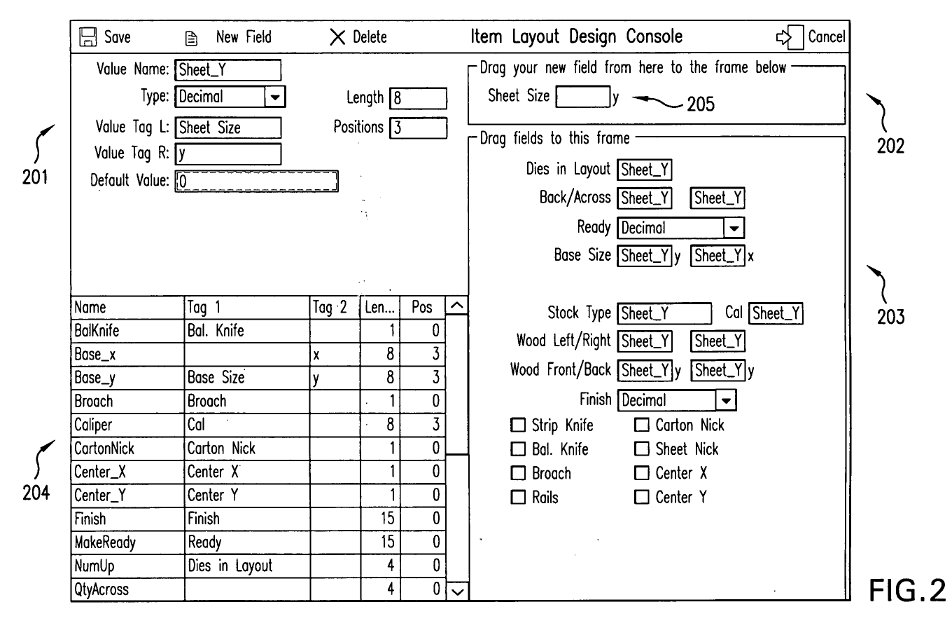

By way of example, and illustrated in FIG. 2, the ILDC can comprise four primary areas: 1) Field Definitions 201 for a new field 205; 2) A View Frame 202 for the new field 205; 3) The Listed details 204 for created fields; and 4) A Layout Frame 203 for existing created fields. An exemplary ILDC is shown in FIG. 2.

In the Field definitions section 201, a design User can begin defining a field 205 that can describe an item of manufacture by creating a name for a new field (labeled “Value Name” in FIG. 2). For example, the field name can comprise alpha-numeric characters plus symbols such as the underscore (_). An exemplary field name can be “Sheet_Y”. The name of a field should be unique for a given item. The ILDC can alert the design User if a field name is given that already exists. The design user can also select the type of field (labeled “Type” in FIG. 2) they wish to add to the layout. For example, the type of field can be selected from a drop down list with four options being Integer, Decimal, Text and Yes/No.

A Value Tag (labeled “Value Tag L” and “Value Tag R” in FIG. 2) entry can be made so that the design User can define how interface users see the field described. The Value Tags can show on the Left and Right of the field in an interface users interface and on a generated report when the field is displayed. In the example given, the interface users interface will show “Sheet Size” on the left of the field and “y” on the right of the field.

When the design User has selected a type of field, the design User can be prompted to provide a maximum length in characters that the field can be (labeled “Length” in FIG. 2). If the design User has selected “Decimal” as the type of field then design User can be prompted to provide the number of decimal positions for the decimal (labeled “Positions” in FIG. 2). For example, the length can include the decimal position where if the interface user expects to store values of 99.999 to 0.000 then the Length of the field should be 5 and the Positions should be 3. This will ensure that data shown throughout the system for this field will always have 3 decimal positions.

The design User can also set a default value for the field (labeled “Default Value” in FIG. 2). The default value can be used to assign a value when the interface User creates a new traveler. This area does not have to be used. This can render the field as a drop down or combo type field where only a selection of possible values is provided. To use this feature, the design User must type a value into the box next to the Default Value tag and press enter. This will add the value to a list to be shown to the interface user.

When the design User enters the ILDC with a new manufactured item or an item that has no layout designed, they can automatically be put into a mode to begin entering data for a new field. Once a field has been created, each new field can be created by selecting New Field in the ILDC header bar, for example. This will clear the Value Name and all corresponding field data so that the new field can be generated. The new field can be shown in the view field frame above the layout frame.

As information is entered for the new field 205, the view frame 202 can show what the new field 205 would look like. When all the data has been given, the design User can move the new field 205 into the layout frame 203. Placement of this field can be performed done by “dragging” the field from the view frame 202 to the layout frame 203. This can complete the creation of the new field 205 for the item of manufacture. The new field 205 can then be shown in the layout detail grid 204 below the definitions section. The design User can also drag and drop the field to new locations within the layout frame 203.

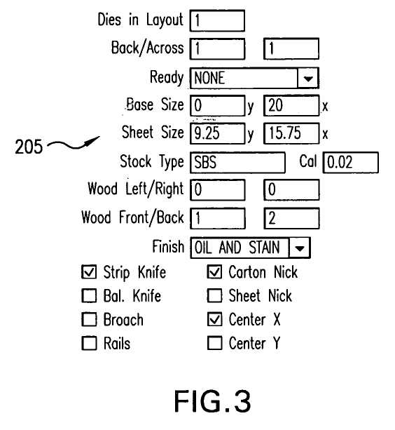

An exemplary layout frame 203 is illustrated in FIG. 3. The new field added is now in the layout frame either as a field by itself or along with several other fields previously defined. The new field 205 added in FIG. 2 is now in the layout frame 203 of FIG. 3. The other fields can be either new or pre-existing from an earlier session. To modify where the field should be located within the layout frame 203, the User can select that field and then “drags” the field to the new location. The ILDC can prevent a user from overlapping fields where any part of the new or moved field is on top or beneath another field in the layout. Rather, as fields are moved, they can “snap” into a location that is closest to where the User was dragging so that it is not overlapping. For example, after a User moved the new field (Sheet_Y) into the layout frame, the user drags the field on top of the (Base Size) field, then the (Sheet_Y) would simply appear just below the (Base Size) and then automatically left align itself so that the layout appears clean and organized. The User can remove a field from the layout frame with some major and possibly severe warnings. For example, if a field had been added and data has been applied to an item in an order, then the User risks losing that data when deleting a field from the report. By way of example, a field can be removed by selecting a field and then selecting the delete button in the ILDC header.

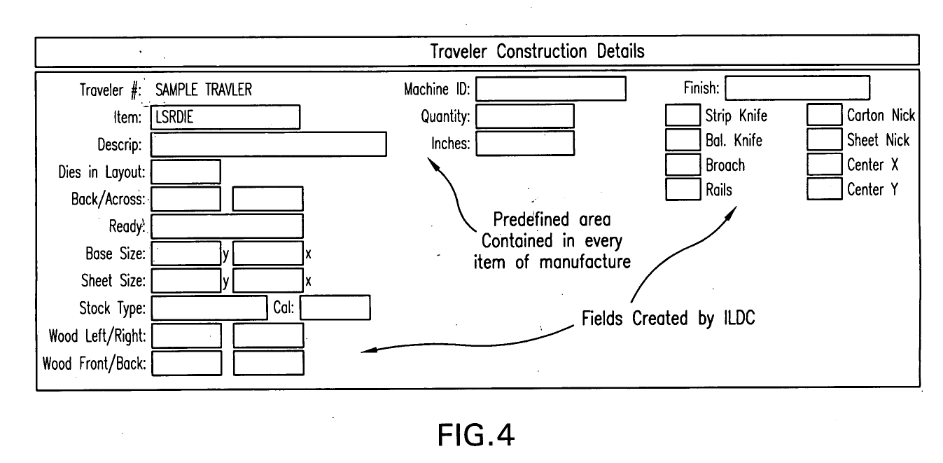

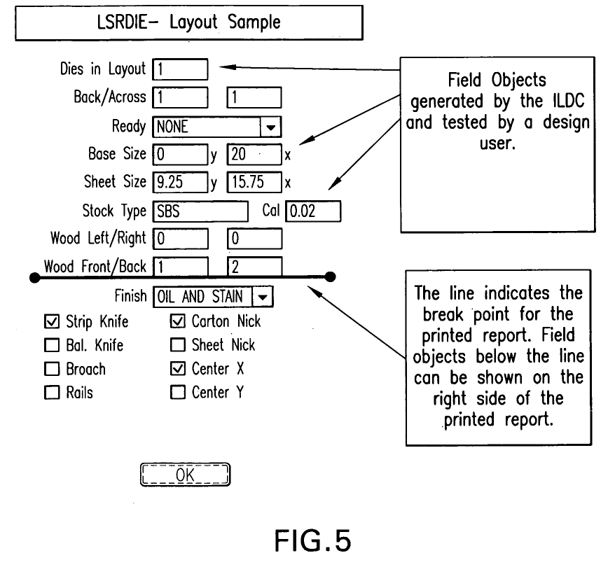

At anytime during the design of the traveler, the User can preview a sample report of the traveler. An exemplary report is shown in FIG. 4. The User can also perform a “try-out” of an interface to see if the fields are working and appearing as they anticipate. An exemplary “try-out” of an interface is shown in FIG. 5. This provides the User the ability operate the controls without accidentally moving the controls.

As the User creates the interface for data entry, they are also creating the layout for a printable report. While the interface layout is shown exactly as the User places fields in the layout frame, the report can show the fields in a top-down order starting on the left side of the page in the item detail information section of the report and continues on the right side of the page. As there is a limited area to the interface to place field objects, there is also a limited area available to print the report. Therefore the report can show the same layout design, but moves fields past a certain mark onto the right side of the printed page. The layout frame can contain a highlighted area indicating where that break point will be.

In one aspect, the data shown in the ILDC is only a portion of the information that is captured when fields are created, moved or modified. For example, the information captured can include a layout ID. The Layout ID can be an automatically generated number stored for each field element created. This is used as an identifier for accessing the data along with a data values table for fields that are choice type fields.

The manufactured item style can be stored as a means of linking the item to the fields used to create the layout for that item. The Item Style can be an alpha numeric code that can be used as a representation of the item of manufacture. This value can be stored in Travelers, Offers, Templates, Time Logs and in Layout Definitions. This can be a value to link information from one table to the item of manufacture. As an example, if the item of manufacture is “Little Red Wagons” then the item style can be stored as “LRW”. The Item Style should be unique to the listing of both items of manufacture and items of purchase in a single table that could be named “Items”.

The field name can be stored as a means of identifying a field object for the User. Two Field Names should not be the same for a single manufactured item. For example, a User can have a ColorType field for Widget01 and also for Widget02 but cannot have two ColorType fields for Widget01. Rather a User should specify ColorType01 and ColorType02.

Value Tags 1 and 2 are Left and Right identifiers for the User of the interface. This data can be stored exactly as the User types it in the ILDC. It is then referenced to show the Interface User when they enter data into an order, or print a report.

Top Position/Left Position are numbers representing a field object's top most position and left most position stored based on its position in the layout frame. These values can then be used to calculate where the field should be displayed in a GUI or in a printed report. The left and top positions can be based on the actual field object and not the tags used to describe the field.

Data type can be used in determining a type of field to be used in the GUI. A data type of Integer, Single or Text will use either an object type of Text or Combo. The only difference between the two is if the user decides that the field may have multiple values to choose from for data entry. For example, the User has chosen a data type of “Text”. The User does not have to place any information as a default, as the expectation is that users of the interface will type any alpha-numeric value into the field object. However the User may want interface users to only have a choice of “Orange, Green, or Red”. The User then enters these values into the values list while designing the item. This will cause the type of field to change from a standard text box to a combo box otherwise called a drop down box. This forces the interface user to choose one of these three values. The report will reflect only the value given and the tags as created by the User. Data Types of Yes/No are also called Logical or LOGI field types. These can be represented by a “Check Box” in the interface and a Yes or No value in the report. The intention for this is that there are only two options possible and that is a yes or no answer, or rather a checked or un-checked field in the interface. As an example, the User wants the interface user to answer a question about an item of manufacture like “Place a company logo on the top?”. The interface will appear so that the interface user can check the box or not have the box checked.

Types of fields, also referred to as object types, can be one of a plurality of values that are used to create a traveler. For example, the object types can be a combo box, a dropdown box, a text box, a check box, and the like. By way of example, value tags for check boxes can appear on the right of the check box. In this case the left value tag field would be irrelevant and would not appear as an option for entry to the design user when the Yes/No data type is chosen. The User does not have to select an object type but rather the other selections made when building the field will cause the object type to be decided for the User. Object type allows the interface to be designed to handle the input needs as collaborated between the User and the interface users. For example, all Yes/No data types can be a check box, all other data types with multiple values will be a combo box, and all other data types will be a text box.

The width of a field can be calculated based on the desired length of characters and potentially decimal positions required when the field is designed or modified. Changes made to the field in the layout detail grid can be reflected in the layout frame. Changes made to new fields as they are being designed can be reflected in the view frame. By way of example, all check box types or Yes/No types can have a set field height and all other field objects created can have a different field height. The field height can be a number representing how tall a field will be when displayed in the user interface or in the printed report. In one aspect, there can be two different heights where check boxes are slightly shorter than other field objects. The length of check boxes can be determined based on the text provided in a value tag entry. A calculation can be made based on the exact text typed and then stored so that check boxes will not be truncated or take up too much space in either the layout or the printed report.

When the User is complete, the traveler design can be saved to the system. Interface users will not see changes until they have been saved by the User, but once changes are made, interface users will instantly see them as they enter, edit or print new manufactured items affected by the designer. Accordingly, this should be a planned and communicated effort by the manufacturer using this system, as new fields are added or existing fields are moved or deleted, it immediately impacts what the interface users will see. Miscommunication in this case could cause the interface user to create or save travel orders without inserting the correct data.

Reports and interfaces can be created at runtime. Runtime is defined by the application is running on a clients computer. Much of the time, programmers create an interface at “Design-Time” where objects are placed in specific locations for a user to see. The application is compiled and the data for where the field objects are imbedded into the application to always be the same place. At runtime, users of these applications then see the field objects and use them as normal. With the use of the ILDC, the present methods and systems, allows for interactive design which is recreated at runtime based on changes made by the User. In one aspect, reporting is done much the same way. The User, at runtime, can use drag-n-drop development to move or create an interface and when they request a printout, the system can use the new interface design to generate a printed copy of their manufactured information.

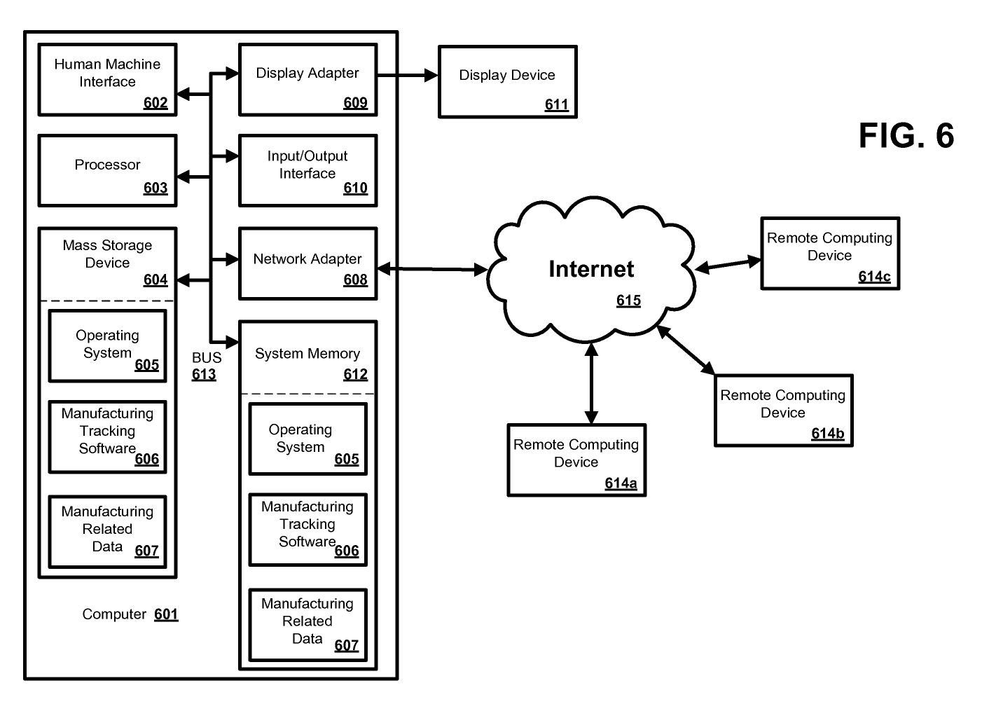

FIG. 6 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment. One skilled in the art will appreciate that this is a functional description and that respective functions can be performed by software, hardware, or a combination of software and hardware.

The present methods and systems can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 601. The components of the computer 601 can comprise, but are not limited to, one or more processors or processing units 603, a system memory 612, and a system bus 613 that couples various system components including the processor 603 to the system memory 612. In the case of multiple processing units 603, the system can utilize parallel computing.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 613, and all buses specified in this description can also be implemented over a wired or wireless network connection and each of the subsystems, including the processor 603, a mass storage device 604, an operating system 605, manufacturing tracking software 606, manufacturing related data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as manufacturing related data 607 and/or program modules such as operating system 605 and manufacturing tracking software 606 that are immediately accessible to and/or are presently operated on by the processing unit 603.

In another aspect, the computer 601 can also comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computer 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and manufacturing tracking software 606. Each of the operating system 605 and manufacturing tracking software 606 (or some combination thereof) can comprise elements of the programming and the manufacturing tracking software 606. Manufacturing related data 607 can also be stored on the mass storage device 604. Manufacturing related data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

Manufacturing data can be a collection of information either in a single or a plurality of databases used to keep track of the items of manufacture and areas related to manufacturing. Manufacturing data can include, but is not limited to, a listing of items that are broken down in sub categories such as the actual items of manufacture, a listing of required material within the item of manufacture, a listing of purchased components, a listing of self-manufactured components, a listing of phantom parts which can be an item that is not a real item but refers to a real item that is either self manufactured or purchased. Manufacturing data can include personnel or employee data required for allowing access to applications used in manufacturing and data for tracking time that an employee spent either manufacturing or preparing to manufacture. The data can contain client related information so that items of manufacture can be tied to a customer and shipped to a customer or to a customer's customer. The data can include machine related data exampled by machines used to produce items of manufacture. This data is relevant to know what employee is assigned to or working on a machine or piece of equipment used to manufacture. Routing or manufacture path information can be included to keep track of what machines are required or what sections of the manufacturing facilities are required to create the item of manufacture. The data can include a listing of vendors from which purchased items are acquired. The data can include a calendar or collection of work days and non-work days. Manufacturing data can contain warehouse information or location information which is used to identify where manufactured or purchased items are stored. Warehouses or locations could refer to any facility where the product is stored or located from the local site or sites to the customer's site or sites. Manufacturing data can include a listing of shipping and or delivery companies as required to deliver the item of manufacture to the customer and can also include a listing of delivery or shipment methods and payment methods. Manufacturing data can contain offer or quoting information, ordering information and template or specification information.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the computer 601 can have more than one display adapter 609 and the computer 601 can have more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computer 601 via Input/Output Interface 610.

The computer 601 can operate in a networked environment using logical connections to one or more remote computing devices 614a,b,c. By way of example, a remote computing device can be a personal computer, portable computer, a server, a router, a network computer, a peer device or other common network node, and so on. Logical connections between the computer 601 and a remote computing device 614a,b,c can be made via a local area network (LAN) and a general wide area network (WAN). Such network connections can be through a network adapter 608. A network adapter 608 can be implemented in both wired and wireless environments. Such networking environments are conventional and commonplace in offices, enterprise-wide computer networks, intranets, and the Internet 615.

For purposes of illustration, application programs and other executable program components such as the operating system 605 are illustrated herein as discrete blocks, although it is recognized that such programs and components reside at various times in different storage components of the computing device 601, and are executed by the data processor(s) of the computer. An implementation of manufacturing tracking software 606 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for creating a custom object comprising:
a. selecting an item of manufacture;
b. determining a plurality of fields to describe the item of manufacture;
c. defining at least one of the plurality of fields;
d. generating an associated visual representation of the at least one of the plurality of fields in a view frame;
e. moving the associated visual representation of the at least one of the plurality of fields to a layout frame in response to a design user input;
f. repeating steps c-e for the plurality of fields that are undefined, resulting in each of the plurality of fields having an associated visual representation in the layout frame; and
g. displaying the layout frame as the custom object.

2. The method of claim 1, wherein the custom object is a custom traveler or a custom quotation.

3. The method of claim 1, wherein determining a plurality of fields to describe the item of manufacture comprises selecting a previously defined plurality of fields.

4. The method of claim 1, wherein defining at least one of the plurality of fields comprises creating a name for the at least one of the plurality of fields.

5. The method of claim 1, wherein defining at least one of the plurality of fields comprises selecting a type for the at least one of the plurality of fields.

6. The method of claim 1, wherein defining at least one of the plurality of fields comprises selecting a value tag for the at least one of the plurality of fields.

7. The method of claim 1, wherein defining at least one of the plurality of fields comprises selecting a field length for the at least one of the plurality of fields.

8. The method of claim 1, wherein defining at least one of the plurality of fields comprises providing a default value for the at least one of the plurality of fields.

9. The method of claim 5, wherein the type selected is one of, integer, decimal, text, or yes/no.

10. The method of claim 1, wherein the at least one of the plurality of fields comprises a price field.

11. The method of claim 1, wherein defining at least one of the plurality of fields comprises creating one or more pricing formulas.

12. The method of claim 11, wherein the one or more pricing formulas determine a quote price based on at least one of the plurality of fields.

13. The method of claim 1, wherein moving the associated visual representation of the at least one of the plurality of fields to a layout frame in response to a design user input comprises dragging and dropping the associated visual representation into the layout frame with a computer input device.

14. The method of claim 1, wherein displaying the layout frame as the custom traveler comprises outputting the custom traveler to a display device.

15. A system for creating a custom object comprising:
a memory, configured for storing at least a plurality of fields;
a processor, coupled to the memory, configured for performing steps comprising,
a. selecting an item of manufacture;
b. determining a plurality of fields to describe the item of manufacture;
c. defining at least one of the plurality of fields;
d. generating an associated visual representation of the at least one of the plurality of fields in a view frame;
e. moving the associated visual representation of the at least one of the plurality of fields to a layout frame in response to a design user input;
f. repeating steps c-e for the plurality of fields that are undefined, resulting in each of the plurality of fields having an associated visual representation in the layout frame; and
g. displaying the layout frame as the custom object.

16. The method of claim 15, wherein the custom object is a custom traveler or a custom quotation.

17. The system of claim 15, wherein determining a plurality of fields to describe the item of manufacture comprises selecting a previously defined plurality of fields.

18. The system of claim 15, wherein defining at least one of the plurality of fields comprises creating a name for the at least one of the plurality of fields.

19. The system of claim 15, wherein defining at least one of the plurality of fields comprises selecting a type for the at least one of the plurality of fields.

20. The system of claim 15, wherein defining at least one of the plurality of fields comprises selecting a value tag for the at least one of the plurality of fields.

21. The system of claim 15, wherein defining at least one of the plurality of fields comprises selecting a field length for the at least one of the plurality of fields.

22. The system of claim 15, wherein defining at least one of the plurality of fields comprises providing a default value for the at least one of the plurality of fields.

23. The system of claim 19, wherein the type selected is one of, integer, decimal, text, or yes/no.

24. The system of claim 15, wherein moving the associated visual representation of the at least one of the plurality of fields to a layout frame in response to a design user input comprises dragging and dropping the associated visual representation into the layout frame with a computer input device.

25. A computer readable medium for creating a custom object having computer executable instructions embodied thereon for performing steps comprising:
a. selecting an item of manufacture;
b. determining a plurality of fields to describe the item of manufacture;
c. defining at least one of the plurality of fields;
d. generating an associated visual representation of the at least one of the plurality of fields in a view frame;
e. moving the associated visual representation of the at least one of the plurality of fields to a layout frame in response to a design user input;
f. repeating steps c-e for the plurality of fields that are undefined, resulting in each of the plurality of fields having an associated visual representation in the layout frame; and
g. displaying the layout frame as the custom object.
